(19) United States
(12) Patent Application Publication
(10) Pub. No.: US 2017/0019818 A1
(43) Pub. Date: Jan. 19, 2017

(54) Method and Device for Processing Parallel transmission, and Computer Storage Medium

(71) Applicant: ZTE Corporation, Shenzhen (CN)

(72) Inventors: Weimin XING, Shenzhen (CN); Nan LI, Shenzhen (CN); Kaibo TIAN, Shenzhen (CN); Ke YAO, Shenzhen (CN)

(21) Appl. No.: 15/281,438

(22) Filed: Sep. 30, 2016

Related U.S. Application Data
(63) Continuation-in-part of application No. PCT/CN2014/086964, filed on Sep. 19, 2014.

(30) Foreign Application Priority Data
May 9, 2014 (CN) 201410196645.7

(51) Int. Cl. H04W 28/26; H04W 74/08

(52) U.S. Cl. CPC H04W 28/26; H04W 74/08; H04W 84/12

(57) ABSTRACT

Provided are a method and a device for processing parallel transmission. The method includes that: node types of multiple secondary nodes used for parallel transmission are determined, the node types include a second-type secondary node supporting or enabling parallel message processing (S202); a resource negotiation manner used for negotiating resources of each secondary node for parallel transmission is determined according to the determined node types (S204); corresponding resources corresponding to the multiple secondary nodes respectively are determined according to the determined resource negotiation manner (S206); and parallel transmission processing is performed on the multiple secondary nodes according to the corresponding resources (S208). By the present disclosure, and the effects of effectively avoiding interference to parallel transmission, effectively achieving compatibility with new and old equipment of the network and effectively improving efficiency of the network are achieved.

### CROSS REFERENCE TO RELATED APPLICATIONS

This application is a continuation-in-part of International Patent Application No. PCT/CN2014/086964 filed on Sep. 19, 2014 which claims priority to Chinese Patent Application No. 201410196645.7 filed on May 9, 2014, where the contents of both of said applications are herein incorporated by reference in their entirety.

### TECHNICAL FIELD

The present disclosure relates to a field of communication, and in particular to a method and a device for processing parallel transmission and a computer storage medium.

### BACKGROUND

At present, with more and more users using Wireless Local Area Network (WLAN) for data communication, network loads of the WLANs constantly increases and efficiency of the WLAN tends to be obviously reduced, simply increasing the rate of the WLAN may not solve this problem. In order to solve the problem of the efficiency of the WLAN, Multi-user data transmission (or named as Multi-user transmission) is proposed in a related art, and a Multi-user transmission technology includes a Multi-User Multiple Input Multiple Output (MU-MIMO) technology (space domain multiple access), an Orthogonal Frequency Division Multiple Access (OFDMA) technology (frequency domain multiple access) and an Interleave-Division Multiple-Access (IDMA) technology (code division domain multiple access). FIG. 1 is a structure diagram of a Basic Service Set (BSS) of a WLAN in the related art, and as shown in FIG. 1, in a WLAN, an Access Point (AP) Station and multiple non-AP Stations (STAs) related to the AP station form a BSS. Multi-user transmission in a WLAN usually refers to that multiple secondary nodes simultaneously send data to a primary node (Uplink multi-user) or the primary node simultaneously sends data to the multiple secondary nodes (Downlink multi-user). Generally, the primary node is an AP or a non-AP STA with a special capability, and the secondary nodes are ordinary non-AP STAs. In addition, the Multi-user transmission is also named as parallel transmission or simultaneous transmission.

Therefore, although a Multi-user transmission mechanism may effectively improve efficiency of a WLAN, an effective parallel transmission link is not able to be established due to own characteristics of the WLAN in the related art and it is consequently impossible to directly implement parallel transmission in the WLAN.

### SUMMARY

Embodiments of the present disclosure provides a method and a device for processing parallel transmission, so as to at least solve the problem that parallel transmission is not able to be directly implemented in a WLAN in the related technology.

According to an aspect of an embodiment of the present disclosure, a method for processing parallel transmission is provided, including: determining node types of multiple secondary nodes used for parallel transmission, and the node types include a second-type secondary node supporting or enabling parallel message processing; determining, according to the determined node types, a resource negotiation manner used for negotiating resources of each secondary node for the parallel transmission; determining corresponding resources corresponding to the multiple secondary nodes respectively according to the determined resource negotiation manner; and performing parallel transmission processing on the multiple secondary nodes according to the corresponding resources.

In an example embodiment, determining, according to the determined node types, the resource negotiation manner used for negotiating the resources of each secondary node for the parallel transmission includes at least one of: when the node types of the multiple secondary nodes further include a first-type secondary node not supporting or enabling the parallel message processing, determining that a resource negotiation manner of respective independent resource negotiation is adopted for the first-type secondary node and the second-type secondary node; when the node types of the multiple secondary nodes merely include the second-type secondary nodes supporting or enabling the parallel message processing, determining that a resource negotiation manner of respective independent resource negotiation is adopted for the second-type secondary nodes; and when the node types of the multiple secondary nodes merely include the second-type secondary nodes supporting or enabling the parallel message processing, determining that a resource negotiation manner of simultaneous parallel negotiation is adopted for the second-type secondary nodes.

In an example embodiment, when the node types of the multiple secondary nodes further include the first-type secondary node not supporting or enabling the parallel message processing, determining the corresponding resources corresponding to the multiple secondary nodes respectively according to the determined resource negotiation manner includes: sending, after corresponding resources of the first-type secondary node on a primary channel is determined, to the second-type secondary node a request message used for requesting for data transmission, and the request message sent to the second-type secondary node includes first resource range information of resources except the resources occupied by the first-type secondary node; and determining corresponding resources of the second-type secondary node according to a response message fed back by the second-type secondary node, and the response message fed back by the second-type secondary node includes information of corresponding resources of the second-type secondary node, and the corresponding resources of the second-type secondary node is selected by the second-type secondary node.

In an example embodiment, the request message sent to the second-type secondary node includes at least one of: a unicast Request To Send, RTS, frame, a unicast predetermined frame and a multicast predetermined frame, and a reserved indicator bit in the unicast RTS frame indicates the carried first resource range information, and an information field of the unicast predetermined frame or the multicast predetermined frame indicates the carried first resource range information; and the response message fed back by the second-type secondary node includes a unicast Clear To Send (CTS) frame or a unicast predetermined response frame, and a reserved indicator bit in the CTS frame fed back by the second-type secondary node indicates the carried information of corresponding resources selected by the second-type secondary node, and an information field of the unicast predetermined response frame indicates the carried information of corresponding resources selected by the second-type secondary node.

In an example embodiment, determining the corresponding resources corresponding to the multiple secondary nodes respectively according to the determined resource negotiation manner further includes: determining that resources corresponding to the first-type secondary node includes primary channel resources, and transmission time of parallel transmission on a secondary channel is determined by data transmission time on the primary channel.

In an example embodiment, when the node types of the multiple secondary nodes merely include the second-type secondary nodes supporting or enabling the parallel message processing, determining the corresponding resources corresponding to the multiple secondary nodes respectively according to the determined resource negotiation manner includes: sending a request message used for requesting for data transmission to the second-type secondary node, and the request message includes second resource range information of resources for the second-type secondary node to select for parallel transmission; and determining corresponding resources of the second-type secondary node according to received response message sent by the second-type secondary node, and the response message includes information of the corresponding resources selected by the second-type secondary node according to the second resource range information.

In an example embodiment, the request message sent to the second-type secondary node includes at least one of: a unicast RTS frame, a unicast predetermined frame and a multicast predetermined frame, and a reserved indicator bit in the RTS frame indicates the carried second resource range information, and an information field of the unicast predetermined frame/the multicast predetermined frame indicates the second resource range information for parallel transmission of the second-type secondary node; and the response message fed back by the second-type secondary node includes a unicast CTS frame or a unicast predetermined response frame, and a reserved indicator bit in the CTS frame indicates the carried information of the corresponding resources selected by the second-type secondary node, and an information field of the unicast predetermined response frame indicates the carried information of corresponding resources selected by the second-type secondary node.

In an example embodiment, performing parallel transmission processing on the multiple secondary nodes according to the corresponding resources includes: sending corresponding data to the multiple secondary nodes at a same time by adopting different corresponding resources, and each piece of data sent to the second-type secondary node includes response parameter adjustment indication information used for adjusting response parameters of the corresponding secondary node responding to the data.

In an example embodiment, before sending the corresponding data to the multiple secondary nodes at the same time by adopting different corresponding resources, further including: acquiring response parameters corresponding to the multiple secondary nodes, and the response parameter adjustment indication information takes a parameter of the first-type secondary node as a criterion when the multiple secondary nodes further include the first-type secondary node not supporting or enabling parallel message processing.

In an example embodiment, the response parameter adjustment indication information includes at least one of: power adjustment information, immediate response sending time point adjustment information and carrier frequency offset pre-adjustment information.

In an example embodiment, and the corresponding resources include at least one of: frequency-domain resources, code division resources and space-domain resources.

In an example embodiment, and, when the corresponding resources are frequency-domain resources, the first resource range information and the second resource range information respectively include at least one of: a starting position and bandwidth information of a frequency band; a temporary primary channel position and bandwidth information of the frequency band; the temporary primary channel position of the frequency band; and sub-channel list information.

According to another embodiment of the present disclosure, a device for processing parallel transmission is provided, including: a first determination component, configured to determine node types of multiple secondary nodes used for parallel transmission, and the node types include a second-type secondary node supporting or enabling parallel message processing; a second determination component, configured to determine, according to the determined node types, a resource negotiation manner used for negotiating resources of each secondary node for the parallel transmission; a third determination component, configured to determine corresponding resources corresponding to the multiple secondary nodes respectively according to the determined resource negotiation manner; and a processing component, configured to perform parallel transmission processing on the multiple secondary nodes according to the corresponding resources.

In an example embodiment, the second determination component includes at least one of: a first determination element, configured to, when the node types of the multiple secondary nodes further include a first-type secondary node not supporting or enabling the parallel message processing, determine that a resource negotiation manner of respective independent resource negotiation is adopted for the first-type secondary node and the second-type secondary node; a second determination element, configured to, when the node types of the multiple secondary nodes merely include the second-type secondary nodes supporting or enabling the parallel message processing, determine that a resource negotiation manner of respective independent resource negotiation is adopted for the second-type secondary nodes; and a third determination element, configured to, when the node types of the multiple secondary nodes merely include the second-type secondary nodes supporting or enabling the parallel message processing, determine that a resource negotiation manner of simultaneous parallel negotiation is adopted for the second-type secondary nodes.

In an example embodiment, the third determination component includes: a first sending element, configured to send, after corresponding resources of the first-type secondary node on a primary channel is determined, to the second-type secondary node a request message used for requesting for data transmission, and the request message sent to the second-type secondary node includes first resource range information of resources except the resources occupied by the first-type secondary node; and a fourth determination element, configured to determine corresponding resources of the second-type secondary node according to the response message fed back by the second-type secondary node, and the response message fed back by the second-type secondary node includes information of corresponding resources of the second-type secondary node, and the corresponding resources of the second-type secondary node is selected by the second-type secondary node.

In an example embodiment, the third determination component further includes: a fifth determination element, configured to determine that the resources corresponding to the first-type secondary node includes primary channel resources, and transmission time of parallel transmission on a secondary channel is determined by data transmission time on the primary channel.

In an example embodiment, the third determination component includes: a second sending element, configured to, when the node types of the multiple secondary nodes merely include the second-type secondary nodes supporting or enabling the parallel message processing, send a request message used for requesting for data transmission to the second-type secondary node, and the request message includes second resource range information of resources for the second-type secondary node to select for parallel transmission; and a sixth determination element, configured to determine corresponding resources of the second-type secondary node according to received response message sent by the second-type secondary node, and the response message includes information of the corresponding resources selected by the second-type secondary node according to the second resource range information.

In an example embodiment, the processing component includes: a third sending element, configured to send corresponding data to the multiple secondary nodes at a same time by adopting different corresponding resources, and each piece of data sent to the second-type secondary node includes response parameter adjustment indication information used for adjusting response parameters of the corresponding secondary node responding to the data.

In an example embodiment, the device further including: an acquisition element, configured to acquire response parameters corresponding to the multiple secondary nodes, and the response parameter adjustment indication information takes a response parameter of the first-type secondary node as a criterion when the multiple secondary nodes further include the first-type secondary node not supporting or enabling parallel message processing.

According to an embodiment of the present disclosure, equipment for processing parallel transmission is provided, including any one of the abovementioned device.

According to an embodiment of the present disclosure, a computer storage medium is provided, in which an execution instruction is stored, and the execution instruction is configured to execute any one of the abovementioned methods.

According to the embodiment of the present disclosure, node types of multiple secondary nodes used for parallel transmission are determined, and the node types include a second-type secondary node supporting or enabling parallel message processing; a resource negotiation manner used for negotiating resources of each secondary node for the parallel transmission is determined according to the determined node types; corresponding resources corresponding to the multiple secondary nodes respectively are determined according to the determined resource negotiation manner; and parallel transmission processing is performed on the multiple secondary nodes according to the corresponding resources, so that the problem that an effective parallel transmission link is not able to be established due to own characteristics of a WLAN in the related art and it is consequently impossible to directly implement parallel transmission in the WLAN is solved, and the effects of effectively avoiding interference to parallel transmission, effectively achieving compatibility with new and old equipment of the network and effectively improving efficiency of the network are further achieved.

### BRIEF DESCRIPTION OF THE DRAWINGS

The drawings described here are adopted to provide further understanding of embodiments of the present disclosure, and form a part of the present disclosure. Schematic embodiments of the present disclosure and descriptions thereof are adopted to explain the embodiments of the present disclosure and should not be considered to be improper limits to the embodiments of the present disclosure. In the drawings:

FIG. 1 is a structure diagram of a BSS of a WLAN in the related art;

FIG. 2 is a flowchart of a method for processing parallel transmission according to an embodiment of the present disclosure;

FIG. 3 is a structure block diagram of a device for processing parallel transmission according to an embodiment of the present disclosure;

FIG. 4 is an example structure block diagram of a second determination component in the device for processing parallel transmission according to an embodiment of the present disclosure;

FIG. 5 is a first example structure block diagram of a third determination component in the device for processing parallel transmission according to an embodiment of the present disclosure;

FIG. 6 is a second example structure block diagram of the third determination component in the device for processing parallel transmission according to an embodiment of the present disclosure;

FIG. 7 is a third example structure block diagram of the third determination component in the device for processing parallel transmission according to an embodiment of the present disclosure;

FIG. 8 is a first example structure block diagram of a processing component in the device for processing parallel transmission according to an embodiment of the present disclosure;

FIG. 9 is a second example structure block diagram of the processing component in the device for processing parallel transmission according to an embodiment of the present disclosure;

FIG. 10 is a diagram of channel division according to an example implementation mode of the present disclosure;

FIG. 11 is a diagram of parallel transmission establishment according to a first example embodiment of the present disclosure;

FIG. 12 is a diagram of parallel transmission establishment according to a second example embodiment of the present disclosure;

FIG. 13 is a diagram of parallel transmission establishment according to a fourth example embodiment of the present disclosure; and

FIG. 14 is a diagram of parallel transmission establishment according to a fifth example embodiment of the present disclosure.

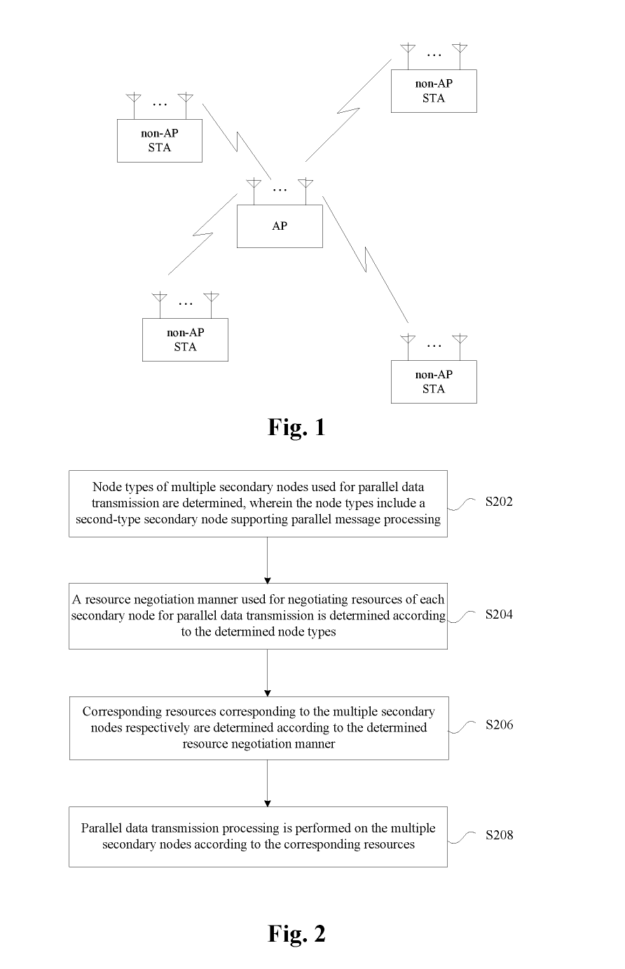

### DETAILED DESCRIPTION OF THE EMBODIMENTS

The embodiments of the present disclosure will be described below with reference to the drawings and embodiments in detail. It is important to note that the embodiments in the present disclosure and characteristics in the embodiments may be combined under the condition of no conflicts.

In the related art, there are some problems during data transmission by parallel technologies such as OFDMA/Frequency Division Multiple Access (FDMA) in a WLAN, which are caused by the following characteristics of the WLAN.

First, the WLAN works in an unlicensed frequency band, there is likely a conflict when STAs compete to send data. Channel resources may be reserved by virtue of a control frame in the WLAN in a related art, so as to protect data transmission. Specifically, channel time, i.e. a Transmission Opportunity (TXOP), may be reserved by interacting an RTS frame and a CTS frame. The above RTS/CTS frame includes a duration indication of the following data transmission to be performed, and the indication may indicate auditing STAs (or third party STAs) around an STA sending the RTS/CTS frame not to compete for the channel. In order to ensure fairness, a time length of the reserved TXOP may not be randomly set but related to a Quality of Service (QoS) parameter of data to be transmitted, and is specifically related to an Access Category (AC) of the data. Different ACs have different limits of the TXOP time length. Parallel transmission involves sending of data of multiple STAs, and may further involve sending of data of multiple ACs, and a sending conflict occurs more probably.

Second, there are both legacy STAs (which may be called first-type equipment) and equipment supporting or enabling new features (for example, equipment supporting or enabling new features defined by the High Efficiency WLAN (HEW) group, which may be called second-type equipment) exist in the WLAN. The new equipment is backwards compatible with the legacy STAs, the two kinds of equipment coexist in the network. However, there is no corresponding compatible mechanism used for supporting or enabling parallel sending of data of the first-type equipment and the second-type equipment in the related art.

Third, a special channel using rule is adopted in the WLAN. A standard defines a minimum basic bandwidth, such as 20 MHz, and a sending bandwidth of all data is required to be the nth power of 2 of the basic bandwidth; and moreover, a primary channel is required to be selected for a BSS. For example, a working bandwidth of a BSS is 80 MHz and includes four 20 MHz sub-channels of which one 20 MHz sub-channel serves as a primary channel of the network and the other sub-channels within 80 MHz serve as secondary channels. Data sending is required to meet a bandwidth requirement of a protocol channel solution, and every sending operation is required to include the primary channel. All equipment detect signals on the primary channel, judges a channel state according to a primary channel detection result, and receives data. It can be seen that an STA triggers data reception through a primary channel carrier monitoring mechanism, and when a primary node directly adopts OFDMA for parallel transmission, all secondary nodes merely detect and receive data including the primary channel and the secondary nodes is not able to know data sending on independent secondary channels, which causes a data sending failure.

For the problems of use of the parallel transmission technologies in the WLAN in the related art, it is mainly obtained by analysis over the problems that there is no effective parallel link establishment process before parallel transmission. On such a basis, the embodiment provides a solution for establishing parallel transmission links and parallel transmission is performed based on the established parallel transmission links.

The embodiment provides a method for processing parallel transmission, FIG. 2 is a flowchart of a method for processing parallel transmission according to an embodiment of the present disclosure, and as shown in FIG. 2, the flow includes the following steps:

In Step 202: node types of multiple secondary nodes used for parallel transmission are determined, and the node types include a second-type secondary node (similar to the abovementioned second-type equipment) supporting or enabling parallel message processing;

In Step 204: a resource negotiation manner used for negotiating resources of each secondary node for parallel transmission is determined according to the determined node types;

In Step 206: corresponding resources corresponding to the multiple secondary nodes respectively are determined according to the determined resource negotiation manner; and

In Step 208: parallel transmission processing is performed on the multiple secondary nodes according to the corresponding resources.

By the steps, for a primary node of a BSS for parallel transmission in a network, the resource negotiation manner is determined according to the node types at first, then the corresponding resources respectively corresponding to the multiple secondary nodes for parallel transmission are determined according to the determined resource negotiation manner, and parallel transmission processing is performed according to the determined corresponding resources. Through determining the corresponding resources corresponding to the nodes used for parallel transmission respectively, interference among the secondary nodes is effectively avoided; and through determining the corresponding resources according to the node types, compatibility among different secondary nodes is effectively achieved. That is, by establishing parallel transmission links, the problem that it is consequently impossible to directly implement parallel transmission in the WLAN, due to that an effective parallel transmission link is not able to be established due to own characteristics of a WLAN in the related art is solved. The effects of effectively avoiding interference to parallel transmission, effectively achieving compatibility with new and old equipment of the network and effectively improving efficiency of the network are further achieved.

The abovementioned processing includes establishment of the parallel transmission links and parallel transmission based on the established parallel transmission links, and the following execution steps may be adopted: the primary node acquires a TXOP, sends a first-type establishment request frame to a first-type secondary node (similar to the abovementioned first-type equipment) not supporting or enabling parallel message processing and receives a first-type establishment response frame sent by the first-type secondary node; and/or, the primary node sends a first-type establishment request frame or a second-type establishment request frame to the second-type secondary node, and receives a first-type establishment response frame or a second-type establishment response frames sent by the second-type secondary node; and the primary node sends parallel radio frames to the secondary nodes, and receives response frames for responding the parallel radio frames from the secondary nodes.

In an example embodiment, the first-type establishment request frame, the first-type establishment response frame, the second-type establishment request frame and the second-type establishment response frame are used for a transmission establishment process before sending of the parallel radio frames. The first-type establishment request frame and the first-type establishment response frame are frames which is able to be parsed by the primary node, the first-type secondary node and the second-type secondary node, and the second-type establishment request frame and the second-type establishment response frame are frames which is able to be parsed by the primary node and the second-type secondary node, and sending frequency bands of the first-type establishment request frame, the first-type establishment response frame, the second-type establishment request frame and the second-type establishment response frame include a primary channel of the network. The operation that the primary node sends the parallel radio frames to the secondary nodes refers to that the primary node transmits data frames to multiple nodes at the same time by virtue of different resources (for example, including at least one of: frequency-domain resources, code division domain resources and space-domain resources).

Descriptions will be made below with reference to specific types of frames corresponding to implementation scenarios.

For different scenarios corresponding to parallel transmission, different resource negotiation manners may also be correspondingly adopted. For example, when the node types of the multiple secondary nodes further include the first-type secondary node not supporting or enabling parallel message processing, it is determined that a resource negotiation manner of respective independent resource negotiation is adopted for the first-type secondary node and the second-type secondary node; when the node types of the multiple secondary nodes merely include the second-type secondary nodes supporting or enabling parallel message processing, it is determined that a resource negotiation manner of respective independent resource negotiation is adopted for the second-type secondary nodes; and when the node types of the multiple secondary nodes merely include the second-type secondary nodes supporting or enabling parallel message processing, it is determined that a resource negotiation manner of simultaneous parallel negotiation is adopted for the second-type secondary nodes.

For different scenarios corresponding to parallel transmission, different processing manners may also be adopted for determining the corresponding resources corresponding to the multiple secondary nodes for parallel transmission respectively according to the determined resource negotiation manner, and specifically, the node types of the multiple secondary nodes may include the first-type secondary nodes and the second-type secondary nodes, and may also merely include the second-type secondary nodes. Descriptions will be made respectively below.

For example, when the node types of the multiple secondary nodes further include the first-type secondary nodes not supporting or enabling parallel message processing, the primary node may determine the corresponding resources of the second-type secondary node after determining the corresponding resources of the first-type secondary node on a primary channel, and transmission time of parallel transmission on a secondary channel is determined by data transmission time on the primary channel; during implementation, the following processing manner may be adopted: the primary node sends a request message used for requesting for data transmission to the second-type secondary node after determining the corresponding resources of the first-type secondary node on the primary channel, and the request message sent to the second-type secondary node includes first resource range information of resources except the resources occupied by the first-type secondary node; and the corresponding resources of the second-type secondary node is determined according to a response message fed back by the second-type secondary node, and the response message fed back by the second-type secondary node includes information of corresponding resources of the second-type secondary node, and the corresponding resources of the second-type secondary node is selected by the second-type secondary node.

In an example embodiment, the request messages sent to the second-type secondary node by the primary node may include at least one of: a unicast RTS frame, a unicast predetermined frame and a multicast predetermined frame, and a reserved indicator bit in the unicast RTS frame indicates the carried first resource range information, and an information field of the unicast predetermined frame or the multicast predetermined frame indicates the carried first resource range information; and the response message fed back by the second-type secondary node includes a unicast CTS frame or a unicast predetermined response frame, and a reserved indicator bit in the unicast CTS frame fed back by the second-type secondary node indicates the carried information of corresponding resources selected by the second-type secondary node, and an information field of the unicast predetermined response frame indicates the carried information of corresponding resources selected by the second-type secondary node.

Based on the scenario corresponding to the resource negotiation manner, descriptions will be made with adoption of the following specific types of frames for the parallel transmission link establishment process as an example. The first-type establishment request frame is an RTS frame, and correspondingly, the first-type establishment response frame sent to the primary node by the first-type secondary node is a CTS frame. The first-type establishment request frame sent to the second-type secondary node is an RTS frame including frequency band range indication information, and correspondingly, the first-type establishment response frame sent by the second-type secondary node is a CTS frame including frequency band range indication information.

For example, when the resources are frequency-domain resources, the frequency band range indication information in the RTS frame indicates a frequency band range indicated by the primary node for the second-type secondary node to use, and the frequency band range indication information in the CTS frame indicates a frequency band range confirmed by the second-type secondary node to use, and the frequency band range indicated by the frequency band range indication information in the CTS frame is a subset of the frequency band range indicated by the frequency band range indication information in the RTS frame. Preferably, the frequency band range indication information may be set in a signaling domain of a physical layer or a Media Access Control (MAC) layer in the RTS frame and the CTS frame.

The second-type establishment request frame may be a parallel transmission request frame, and when there is at least one piece of second-type secondary node information is included, the second-type secondary node information at least includes the frequency band range indication information and node identification information; and the second-type establishment response frame may be a parallel transmission response frame and at least include the frequency band range indication information, and the frequency band range indication information indicates a starting position and bandwidth information of a frequency band, or indicates a temporary primary channel position and bandwidth information of the frequency band, or indicates sub-channel list information, or indicates temporary primary channel position information.

In an example embodiment, the temporary primary channel position information indicates a position of the primary channel temporarily adopted by the secondary node for parallel transmission. The parallel radio frames may include data of multiple secondary nodes, and data sent to the second-type secondary node includes response parameter adjustment indication information. The response parameter adjustment indication information is determined by the primary node according to a predefined criterion.

In an example embodiment, when the parallel radio frame further include data of the first-type secondary node, the response parameter adjustment indication information is determined by the primary node by taking a response parameter of the first-type secondary node as a criterion, and the response parameter adjustment indication information includes at least one of the following information: power adjustment information, immediate response sending time point adjustment information and carrier frequency offset pre-adjustment information. In an example embodiment, the response parameter adjustment indication information may be set in a header part of an MAC layer frame of the data and/or a header part of a physical layer frame of the data.

For another example, when the node types of the multiple secondary nodes merely include the second-type secondary node supporting or enabling parallel message processing, the corresponding resources corresponding to the multiple secondary nodes respectively are determined according to the determined resource negotiation manner. The following processing manner may be adopted, and it is important to note that processing, which is similar to the processing performed when the node types further include the first-type secondary node not supporting or enabling parallel message processing, will not be elaborated herein.

The primary node sends a request message used for requesting for data transmission to the a second-type secondary node, and the request message includes second resource range information of resources for the second-type secondary node to select for parallel transmission; and the primary node determines the corresponding resources of the second-type secondary node according to a received response message sent by the second-type secondary node, and the response message includes information of the corresponding resources selected by the second-type secondary node according to the second resource range information. In an example embodiment, the request message sent to the second-type secondary node includes at least one of: a unicast RTS frame, a unicast predetermined frame and a multicast predetermined frame, and a reserved indicator bit in the RTS frame indicates the carried second resource range information, and an information field of the unicast predetermined frame/the multicast predetermined frame indicates the second resource range information for parallel transmission of the second-type secondary node; and the response message fed back by the second-type secondary node includes a unicast CTS frame or a unicast predetermined response frame, and a reserved indicator bit in the CTS frame indicates the carried information of the corresponding resources selected by the second-type secondary node, and an information field of the unicast predetermined response frame indicates the carried information of corresponding resources selected by the second-type secondary node.

In an example embodiment, when parallel transmission processing is performed on the multiple secondary node according to the corresponding resources, corresponding data may be sent to the multiple secondary nodes at the same time by adopting different corresponding resources, and each piece of data sent to the second-type secondary node includes the response parameter adjustment indication information used for adjusting response parameters to respond the data by the corresponding secondary node. It is important to note that it is also necessary to acquire the response parameters corresponding to the multiple secondary nodes before the corresponding data are sent to the multiple secondary nodes at the same time by adopting different corresponding resources, and the primary node determines the response parameter adjustment indication information according to the predetermined criterion when the multiple secondary nodes are all second-type secondary nodes; and when the multiple secondary nodes further include the first-type secondary node not supporting or enabling parallel message processing, the response parameter adjustment indication information may be determined by taking the response parameter of the first-type secondary node as a criterion. In an example embodiment, the response parameter adjustment indication information may include multiple types, and for example, may include at least one of: power adjustment information, immediate response sending time point adjustment information and carrier frequency offset pre-adjustment information.

It is important to note that the step that the corresponding resources corresponding to the multiple secondary nodes respectively are determined according to the determined resource negotiation manner may further include that: it is determined that the resources corresponding to the first-type secondary node include resources of the primary channel, and the transmission time of parallel transmission on the secondary channel is determined by the data transmission time on the primary channel. That is, an upper time limit of the TXOP acquired by the primary node is equal to a TXOP limit of an AC corresponding to the data occupying the primary channel in the parallel radio frame.

In addition, the corresponding resources may be multiple types of resources, and for example, may include at least one of: frequency-domain resources, code division resources and space-domain resources. When the corresponding resources are frequency-domain resources, the first resource range information and the second resource range information include at least one of: a starting position and bandwidth information of a frequency band; a temporary primary channel position and bandwidth information of the frequency band; the temporary primary channel position of the frequency band; and sub-channel list information.

The embodiment further provides a device for processing parallel transmission, which is configured to implement the abovementioned embodiment and example implementation modes, and that what has been described will not be elaborated. For example, term “component”, used below, may implement a combination of software and/or hardware with a preset function. Although the device described in the following embodiment is preferably implemented with software, implementation with hardware or a combination of software and hardware is also possible and conceivable.

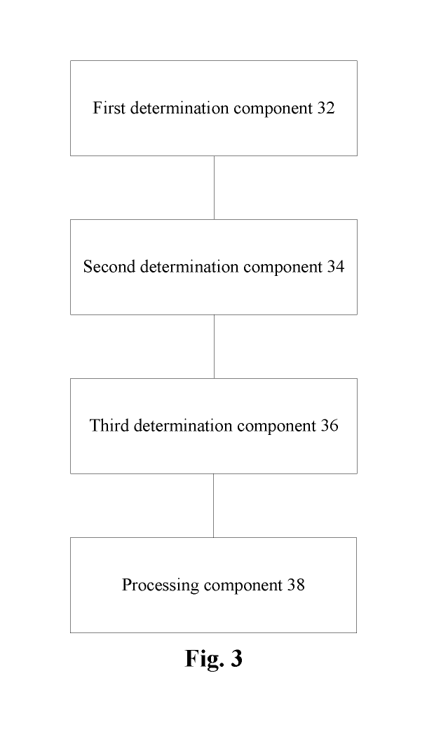

FIG. 3 is a structure block diagram of a device for processing parallel transmission according to an embodiment of the present disclosure, and as shown in FIG. 3, the device includes a first determination component 32, a second determination component 34, a third determination component 36 and a processing component 38. The device will be described below.

The first determination component 32 is configured to determine node types of multiple secondary nodes used for parallel transmission, and the node types include a second-type secondary node supporting or enabling parallel message processing; the second determination component 34 is connected to the first determination component 32, and is configured to determine, according to the determined node types, a resource negotiation manner used for negotiating resources of each secondary node for the parallel transmission; the third determination component 36 is connected to the second determination component 34, and is configured to determine corresponding resources corresponding to the multiple secondary nodes respectively according to the determined resource negotiation manner; and the processing component 38 is connected to the third determination component 36, and is configured to perform parallel transmission processing on the multiple secondary nodes according to the corresponding resources.

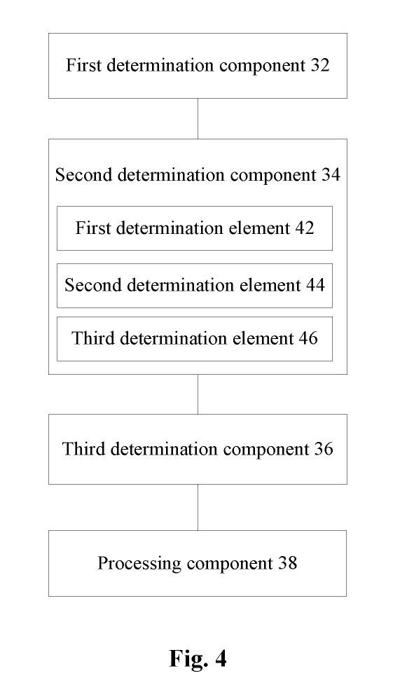

FIG. 4 is an example structure block diagram of the second determination component 34 in the device for processing parallel transmission according to an embodiment of the present disclosure, and as shown in FIG. 4, the second determination component 34 includes at least one of: a first determination element 42, a second determination element 44 and a third determination element 46. The second determination component 34 will be described below.

The first determination element 42 is configured to, when the node types of the multiple secondary nodes further include a first-type secondary node not supporting or enabling the parallel message processing, determine that a resource negotiation manner of respective independent resource negotiation is adopted for the first-type secondary node and the second-type secondary node; the second determination element 44 is configured to, when the node types of the multiple secondary nodes merely include the second-type secondary nodes supporting or enabling the parallel message processing, determine that a resource negotiation manner of respective independent resource negotiation is adopted for the second-type secondary nodes; and the third determination element 46 is configured to, when the node types of the multiple secondary nodes merely include the second-type secondary nodes supporting or enabling the parallel message processing, determine that a resource negotiation manner of simultaneous parallel negotiation is adopted for the second-type secondary nodes.

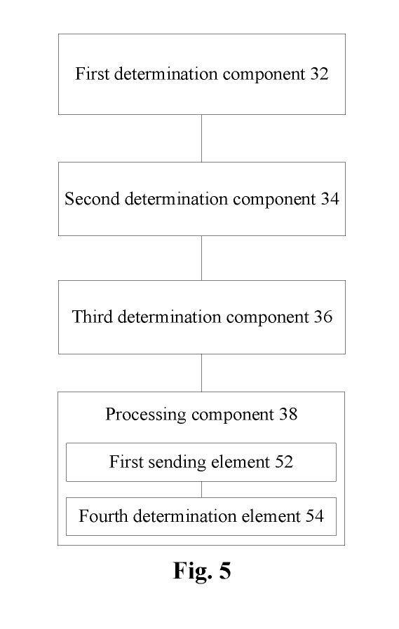

FIG. 5 is a first example structure block diagram of the third determination component 36 in the device for processing parallel transmission according to an embodiment of the present disclosure, and as shown in FIG. 5, the third determination component 36 includes a first sending element 52 and a fourth determination element 54. The third determination component 36 will be described below.

The first sending element 52 is configured to send a request message used for requesting for data transmission to the second-type secondary node after the corresponding resources of the first-type secondary node on a primary channel is determined, and the request message sent to the second-type secondary node includes first resource range information of resources except the resources occupied by the first-type secondary node; and the fourth determination element 54 is connected to the first sending element 52, and is configured to determine the corresponding resources of the second-type secondary node according to the response message fed back by the second-type secondary node, and the response message fed back by the second-type secondary node includes information of corresponding resources of the second-type secondary node, and the corresponding resources of the second-type secondary node is selected by the second-type secondary node.

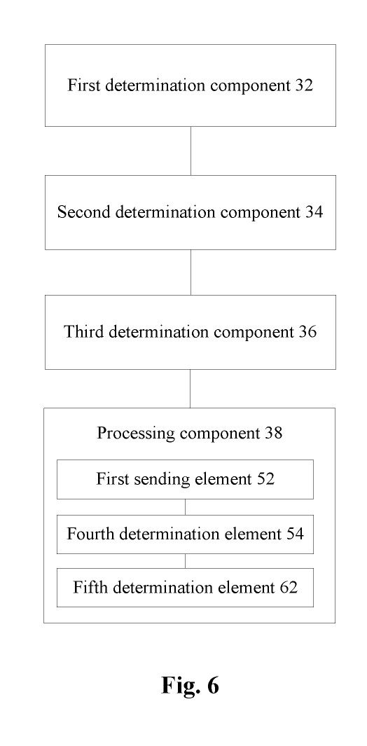

FIG. 6 is a second example structure block diagram of the third determination component 36 in the device for processing parallel transmission according to an embodiment of the present disclosure, and as shown in FIG. 6, the third determination component 36 further, besides all the structures shown in FIG. 5, includes: a fifth determination element 62. The fifth determination element 62 will be described below.

The fifth determination element 62 is connected to the fourth determination element 54, and is configured to determine that the resources corresponding to the first-type secondary node includes the primary channel resources, and transmission time of parallel transmission on a secondary channel is determined by data transmission time on the primary channel.

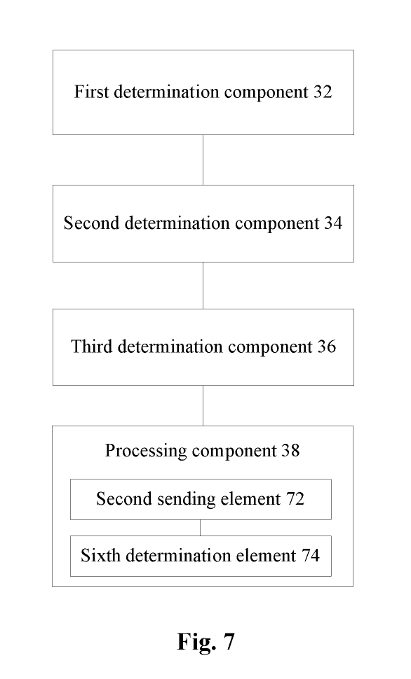

FIG. 7 is a third example structure block diagram of the third determination component 36 in the device for processing parallel transmission according to an embodiment of the present disclosure, and as shown in FIG. 7, the third determination component 36 includes a second sending element 72 and a sixth determination element 74. The third determination component 36 will be described below.

The second sending element 72 is configured to, when the node types of the multiple secondary nodes merely include the second-type secondary nodes supporting or enabling the parallel message processing, send a request message used for requesting for data transmission to the second-type secondary node, and the request message includes second resource range information of resources for the second-type secondary node to select for parallel transmission; and the sixth determination element 74 is connected to the second sending element 72, and is configured to determine corresponding resources of the second-type secondary node according to received response message sent by the second-type secondary node, and the response message includes information of the corresponding resources selected by the second-type secondary node according to the second resource range information.

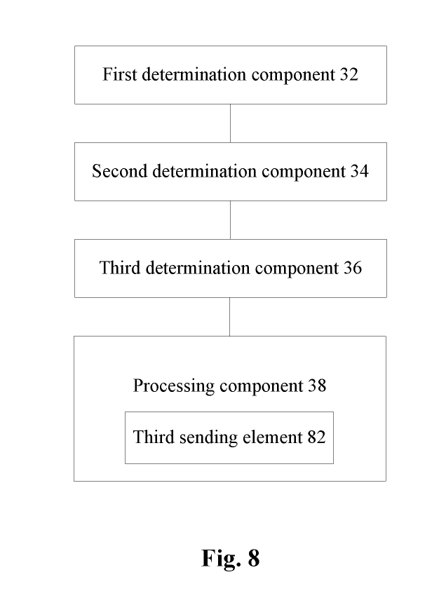

FIG. 8 is a first example structure block diagram of the processing component 38 in the device for processing parallel transmission according to an embodiment of the present disclosure, and as shown in FIG. 8, the processing component 38 includes a third sending element 82. The third sending element 82 will be described below.

The third sending element 82 is configured to send corresponding data to the multiple secondary nodes at a same time by adopting different corresponding resources, and each piece of data sent to the second-type secondary node includes response parameter adjustment indication information used for adjusting response parameters of the corresponding secondary node responding to the data.

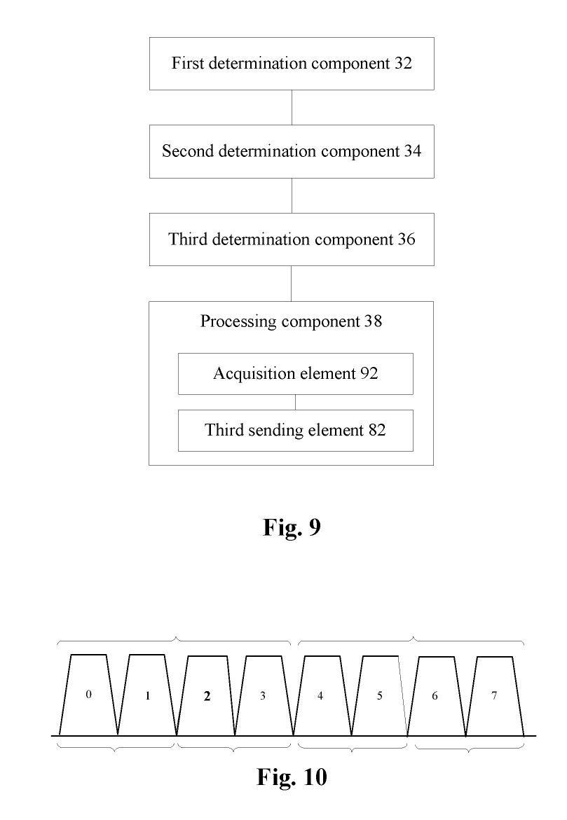

FIG. 9 is a second example structure block diagram of the processing component 36 in the device for processing parallel transmission according to an embodiment of the present disclosure, and as shown in FIG. 9, the processing component 38 further, besides all the structures shown in FIG. 8, includes an acquisition element 92. The acquisition element 92 will be described below.

The acquisition element 92 is connected to the third sending element 82, and is configured to acquire response parameters corresponding to the multiple secondary nodes, and the response parameter adjustment indication information takes a response parameter of the first-type secondary node as a criterion when the multiple secondary nodes further include the first-type secondary node not supporting or enabling parallel message processing.

The embodiment of the present disclosure further provides equipment for processing parallel transmission, which includes any abovementioned device for processing parallel transmission.

The embodiment of the present disclosure further provides a computer storage medium, in which an execution instruction is stored, and the execution instruction is configured to execute any abovementioned method for processing parallel transmission.

According to the establishment method for parallel Multi-user transmission in the WLAN in the abovementioned embodiments and example embodiments, interference brought by parallel transmission may be effectively avoided, problems about synchronization, channel usage and scheduling and the like for parallel transmission in the related art are effectively solved, compatibility with conventional WLAN equipment may be achieved, and efficiency of the network is effectively improved.

Example implementation modes of the present disclosure will be described below with reference to the drawings.

Before the example implementation modes are described, contents indicated by frequency range indication information under different conditions are described when resources configured to parallel transmission are frequency-domain resources.

It is supposed that a running bandwidth of a network is 160 MHz, each sub-channel occupies 20 MHz and the sub-channel numbers are to be 0, 1, 2, 3, 4, 5, 6 and 7 respectively. A primary channel of a BSS is sub-channel 2. FIG. 10 is a diagram of channel division according to an example implementation mode of the present disclosure, and as shown in FIG. 10, four 40 MHz channels and two 80 MHz channels are also defined by the channel division, and for example, 0 and 1 may form a 40 MHz channel, but 1 and 2 is not able to form a 40 MHz channel.

The frequency range indication information may include a starting position of a frequency band (or called a starting position of a channel) and bandwidth information. For example, the number of indicator bits of the starting position of the channel is 3, the number of indicator bits of a channel bandwidth is 2, and when a value indicated by the starting position of the channel is “100” and a value indicated by the channel bandwidth is “01”, it is indicated that a frequency range is a 40 MHz bandwidth started from sub-channel 4 and including sub-channels 4 and 5.

The frequency range indication information may include a temporary primary channel position and bandwidth information of the frequency band. For example, when an indicated temporary primary channel is primary channel 6 and a channel bandwidth is 80 MHz, the frequency range is an 80 MHz bandwidth including sub-channels 4, 5, 6 and 7 according to the channel division.

The frequency range indication information may include the temporary primary channel position of the frequency band, and a physical layer frame header of a radio frame includes a sending bandwidth indicator of the radio frame. For example, when a temporary primary channel position of a certain STA is determined to be sub-channel 6 in a parallel transmission establishment process, the STA performs carrier detection by taking sub-channel 6 as a temporary primary channel during parallel transmission, and acquires specific data bandwidth information according to a detection result and a physical frame header sent on the temporary primary channel.

The frequency range indication information may include sub-channel list information. For example, 8 bits may be adopted to indicate available sub-channels respectively, and when the 8 bits are “01001111”, it is indicated that sub-channels 1, 4, 5, 6 and 7 are available.

### Embodiment 1

An AP and multiple non-AP STAs form a BSS, and a running bandwidth of the BSS is 40 MHz, including a 20 MHz primary channel and a 20 MHz secondary channel, but STA1 is a legacy STA merely supporting or enabling standard 11a and supports a maximum bandwidth of 20 MHz and STA2 is an HEW STA supporting or enabling OFDMA transmission and a 40 MHz bandwidth. Default detection channels of all the STAs at least include the primary channel.

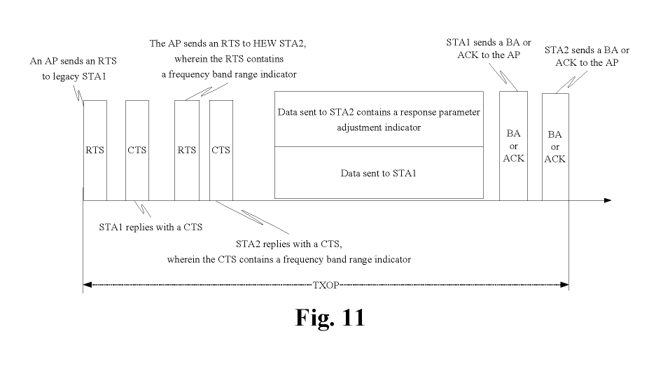

FIG. 11 is a diagram of parallel transmission establishment according to a first example embodiment of the present disclosure, and as shown in FIG. 11, when expecting to use an OFDMA technology to transmit data to STA1 and STA2 in parallel, the AP competes to acquire a TXOP and initiates a parallel transmission establishment process.

The AP sends an RTS frame to STA1, and STA1 replies with a CTS frame after receiving the RTS frame; and then the AP sends an RTS frame to STA2, and the RTS frame contains frequency band range indication information and the frequency band range indication information indicates that a frequency band resource available for data of STA2 during subsequent OFDMA parallel transmission is a secondary channel, and STA2 replies with a CTS frame, and the CTS frame contains the frequency band range indication information to confirm to use the secondary channel. In such a process, the AP and STA2 adopt a reserved indicator bit in a conventional RTS/CTS frame to contain the frequency band range indication information, and specifically adopt a reserved bit in a service field in the RTS/CTS frame. The RTS/CTS frame adopts a conventional frame format, and a sending channel includes the primary channel to enable all the STAs to monitor the RTS/CTS frame. The RTS/CTS frame contains duration indication information used for reserving time to be occupied by a current TXOP. Auditing STAs will not compete for the channel to protect the TXOP after monitoring the information, and an upper time length limit of the TXOP is a TXOP limit corresponding to an AC of sent data of STA1 on the primary channel, and for example, when the data of STA1 belongs to a video AC (AC_VO), the upper time length of the TXOP acquired by the AP is a TXOP limit corresponding to AC_VO. It can be seen that the AP performs RTS/CTS interaction with STA1 and STA2 to protect two links adopted for parallel transmission respectively.

After the abovementioned process is implemented, STA1 waits to receive data on the primary channel, STA2 waits to receive data on the secondary channel, and the AP sends the data to STA1 and STA2 in parallel in an OFDMA manner, and a subcarrier on the primary channel bears the data of STA1, a subcarrier on the secondary channel bears the data of STA2, the data frame sent to STA1 requires an immediate Acknowledgement (ACK)/Block Acknowledgement (BA), and STA1 replies with the ACK/BA after an inter-frame time interval after finishing receiving the data; and the data frame sent to STA2 requires an ACK/BA, the data frame includes an response parameter adjustment indicator, specifically an immediate response sending time point adjustment information, indicating that STA2 replies with the ACK/BA after a time delay T, and the time delay T includes time during STA1 transmits the ACK/BA and a proper inter-frame time interval.

After data reception is finished, STA1 immediately replies with the ACK/BA after the inter-frame time interval, and STA2 replies with the ACK/BA after the time delay T according to the information indicated by the response parameter adjustment indicator.

### Embodiment 2

An AP and multiple non-AP STAs form a BSS, and a running bandwidth of the BSS is 80 MHz, including a 20 MHz primary channel (supposed to be sub-channel 0) and three 20 MHz secondary channels (sub-channels 1, 2 and 3), but STA1 is a legacy STA merely supporting or enabling standard 11n and supports a maximum bandwidth of 40 MHz and STA2 is an HEW STA supporting or enabling OFDMA transmission and a 80 MHz bandwidth. Default detection channels of all the STAs at least include the primary channel.

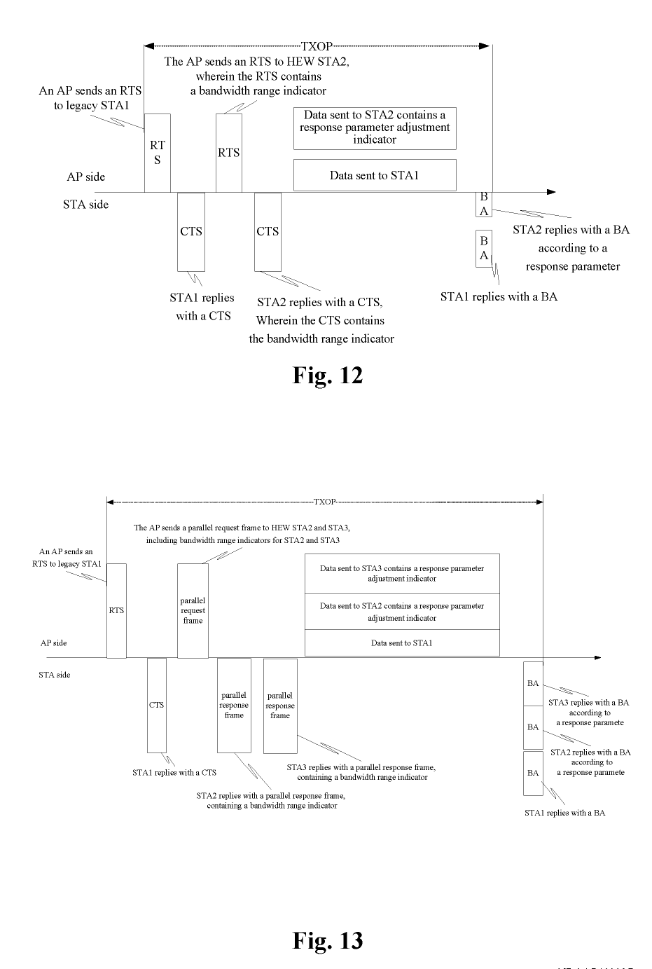

FIG. 12 is a diagram of parallel transmission establishment according to a second example embodiment of the present disclosure, and as shown in FIG. 12, when expecting to use an OFDMA technology to transmit data to STA1 and STA2 in parallel, the AP competes to acquire a TXOP, and initiates a parallel transmission establishment process.

The AP sends an RTS frame to STA1, STA1 replies with a CTS frame after receiving the RTS frame, and STA1 always performs sending and reception on 40 MHz including the primary channel; and then the AP sends an RTS frame to STA2, the RTS frame including frequency band range indication information and the frequency band range indication information indicating that a frequency band resource available for data of STA2 during subsequent OFDMA parallel transmission is secondary channels 2 and 3, and STA2 replies with a CTS frame, the CTS frame including the frequency band range indication information to confirm that a channel to be used is channel 3, that is, the AP and STA2 may negotiate the frequency band to be used. It can be seen that the AP performs RTS/CTS interaction with STA1 and STA2 to protect two links adopted for parallel transmission respectively.

After the abovementioned process is implemented, STA1 waits to receive data on the primary channel, STA2 waits to receive data on secondary channel 3, and the AP sends the data to STA1 and STA2 in parallel in an OFDMA manner, and subcarriers on the primary channel and secondary channel 1 bear the data of STA1, a subcarrier on secondary channel 3 bears the data of STA2, the data frame sent to STA1 requires an immediate ACK/BA, and STA1 replies with the BA after an inter-frame time interval after finishing receiving the data; the data frame sent to STA2 requires an immediate BA, the BA of STA2 and the BA of STA1 are send in parallel on different sub-channels, and the data frame sent to STA2 includes an response parameter adjustment indicator, and the response parameter adjustment indicator may specifically include power adjustment information, an immediate response sending time point adjustment information and carrier frequency offset pre-adjustment information, and the response parameter adjustment indicator indicates STA2 to adjust own BA sending time point according to the immediate response sending time point adjustment information. A carrier spectrum for sending the BA is adjusted according to the carrier frequency offset pre-adjustment information and a power for sending the BA is adjusted according to the power adjustment information (for example, the power adjustment information includes information used for requiring that the power of the BA sent to the AP by the STA2 reaches a target receiving power) to ensure that the BA sent by STA2 and the BA sent by STA1 may be transmitted in parallel and correctly received by the AP. All or part of the response parameter adjustment indicators may be positioned in a MAC header of the data frame, may specifically be positioned in a reserved bit of the MAC header and may be set in an additional information field of the MAC header; and all or part of the response parameter adjustment indicators may also be positioned in a physical layer frame header of the data frame. For example, the physical layer frame header (preamble) may include the carrier frequency offset pre-adjustment information. STA2 may acquire the carrier frequency offset pre-adjustment information from the physical layer frame header of the data frame sent by the AP, and adjust a carrier frequency offset used for sending the BA. When STA2 acquires the carrier frequency offset pre-adjustment information from the physical layer frame header of the data frame sent by the AP, STA2 may acquire the carrier frequency offset pre-adjustment information by detecting and measuring the physical layer frame header of the data frame sent by the AP.

STA1 immediately replies with the BA on the primary channel and secondary channel 1 after the inter-frame time interval, and STA2 sends the BA on channel 3 according to the response parameter adjustment indicator, that is, a sending frequency band of the BA is the same as a frequency band of own received data.

It needs to be noted that 20 MHz being a basic bandwidth of a sub-channel is taken as an example in the OFDMA parallel transmission or multi-users parallel transmission of the present embodiment. The bandwidth of the sub-channel is not limited to the 20 MHz, and may be larger than or smaller than 20 MHz.

### Embodiment 3

An AP and multiple non-AP STAs form a BSS, and a running bandwidth of the BSS is 160 MHz, including a 20 MHz primary channel (supposed to be sub-channel 0) and seven 20 MHz secondary channels (sub-channels 1, 2, 3, 4, 5, 6 and 7), but STA1 is a legacy STA merely supporting or enabling standard 11ac and supports a maximum bandwidth of 160 MHz and STA2 and STA3 are HEW STAs supporting or enabling OFDMA transmission and a 160 MHz bandwidth. When expecting to use an OFDMA technology to transmit data to STA1, STA2 and STA3 in parallel, the AP competes to acquire a TXOP, and initiates a parallel transmission establishment process.

The AP sends an RTS frame to STA1, indicates that a bandwidth may be dynamically adjusted during communication with STA1 and indicates that a bandwidth available for STA1 is 160 MHz; STA1 replies with a CTS frame and indicates that a 40 MHz bandwidth is selected for communication with the AP after receiving the RTS frame, and a channel may be determined merely by indicating a bandwidth value in a related art, and for example, the 40 MHz bandwidth is a 40 MHz bandwidth including the primary channel, i.e. two sub-channels 0 and 1 in the embodiment. Then the AP sends an RTS frame to STA2, and the RTS frame includes frequency band range indication information and the frequency band range indication information indicates a frequency band resource available for data of STA2 during subsequent OFDMA parallel transmission, for example, an information indication method in embodiment 1 may be adopted, that is, channels, i.e. secondary channels 2, 3, 4, 5, 6 and 7, except the channels selected by STA1 are indicated. Then STA2 replies with a CTS frame, and the frame includes frequency band range indication information to confirm the channels to be used are channels 2 and 3, that is, the AP and STA2 may negotiate about frequency bands to be used. Finally, the AP sends an RTS frame to STA3, and the RTS frame includes frequency band range indication information and the frequency band range indication information indicates a frequency band resource available for data of STA3 during subsequent OFDMA parallel transmission, that is, channels, i.e. secondary channels 4, 5, 6 and 7, except the channels selected by STA1 and STA2 are indicated; and STA3 replies with a CTS frame, and the frame includes frequency band range indication information to confirm that channels to be used are channels 4, 5, 6 and 7. It can be seen that the AP performs RTS/CTS interaction with STA1, STA2 and STA3 to protect three links adopted for parallel transmission respectively.

After the abovementioned process is implemented, the AP sends data in parallel in the OFDMA manner, and subcarriers on the primary channel and secondary channel 1 bear data of STA1, subcarriers on secondary channels 2 and 3 bear data of STA2 and subcarriers on secondary channels 4, 5, 6 and 7 bear data of STA3. The data frame sent to STA1 requires an immediate BA, and STA1 replies with the BA after an inter-frame time interval after finishing receiving the data; and the data frames sent to STA2 and STA3 require BAs, that is, STA2 and STA3 reply with BAs for the data frames after receiving Block ACK Request (BAR) sent by the AP.

After the data frames are sent in parallel, STA1 replies with the BA, the AP sends a BAR to STA2 after receiving the BA of STA1, STA2 replies with the BA, then the AP sends a BAR to STA3, and STA3 replies with the BA.

### Embodiment 4

An AP and multiple non-AP STAs form a BSS, and a running bandwidth of the BSS is 160 MHz, including a 20 MHz primary channel (supposed to be sub-channel 0) and seven 20 MHz secondary channels (sub-channels 1, 2, 3, 4, 5, 6 and 7), but STA1 is a legacy STA merely supporting or enabling standard 11ac and supports a maximum bandwidth of 160 MHz and STA2 and STA3 are HEW STAs supporting or enabling OFDMA transmission and a 160 MHz bandwidth.

FIG. 13 is a diagram of parallel transmission establishment according to a fourth example embodiment of the present disclosure, and as shown in FIG. 13, the AP may implement a parallel transmission establishment process by virtue of a parallel transmission request frame and a parallel transmission response frame. The parallel transmission request frame and the parallel transmission response frame are newly-defined frame formats, and may not be parsed by the first-type STA, and a method for using these frames may be as follows.

When STAs for multi-user parallel transmission include a first-type STA and a second-type STA, a conventional frame may be adopted to establish transmission link with the first-type STA, then a newly-defined parallel transmission request frame and a response frame may be adopted to establish transmission link with the second-type STA. A RTS/CTS frame is adopted for communication with STA1, the parallel transmission request frame is adopted for communication with STA2 and STA3. Specifically, the AP sends the parallel transmission request frames to STA2 and STA3, the frames contains identification information and frequency band range indication information of STA2 and STA3 respectively, and STA2 and STA3 sequentially reply with the parallel transmission response frames.

When the STAs for multi-user parallel transmission are all second-type STAs, for example, STA2 and ST3, the AP sends the parallel transmission request frames to STA2 and STA3, and the frames include the identification information and frequency band range indication information of STA2 and STA3 respectively, and STA2 and STA3 sequentially reply with the parallel transmission response frames.

### Embodiment 5

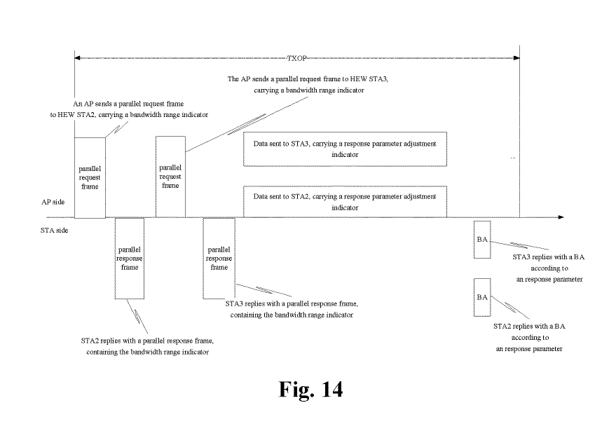

FIG. 14 is a diagram of parallel transmission establishment according to a fifth example embodiment of the present disclosure, and as shown in FIG. 14, an AP may implement a parallel transmission establishment process by virtue of a parallel transmission request frame and a parallel transmission response frame. The parallel transmission request frame and the parallel transmission response frame are newly-defined frame formats, and may not be parsed by a first-type STA, and a method for using these frames may be as follows.

The AP sends a parallel transmission request frame to STA2 and receives a parallel transmission response frame of STA2, and the AP also implements the same process with STA3. The parallel transmission request frame and the response frame include frequency band range indication information.

### Embodiment 6

An AP and multiple non-AP STAs form a BSS, and a running bandwidth of the BSS is 80 MHz, including a 20 MHz primary channel and three 20 MHz secondary channels, but STA1 is an HEW STA which is not enabling/supporting uplink OFDMA transmission.

The AP sends a parallel transmission request frame multi-user RTS (MU-RTS) to STA2˜STA4 and receives a parallel transmission response frame CTS from STA2˜STA4. The MU-RTS frame includes the identification information and frequency band range indication information of STA2˜STA4 respectively, and STA2˜STA4 simultaneously reply to AP with the CTS frame on the frequency band according to the frequency band range indication information in MU-RTS frame.

Before sending the CTS frame, STA2˜STA4 adjusting response parameters according to the parameters of the primary node as a criterion, wherein the response parameter adjustment information comprises at least one of:

power adjustment information used for adjusting a power of sending the response message, immediate response sending time point adjustment information used for adjusting a sending time point of the response message, and carrier frequency offset pre-adjustment information used for adjusting a carrier frequency of sending the response message.

For example, STA2 may measures a different between the carriers frequency of the STA2 and the carrier frequency of the AP by detecting the MU-RTS sent by the AP, acquire carrier frequency offset pre-adjustment information by taking the carrier frequency of the AP, adjust the carrier frequency offset and send a CTS frame.

Meanwhile, STA2˜STA4 may further adjust a power and delay of sending the CTS according to explicit or implicit indication of the AP.

Obviously, those skilled in the art should know that each component or step of the embodiment of the present disclosure may be implemented by a universal computing device, and the components or steps may be concentrated on a single computing device or distributed on a network formed by a plurality of computing devices, and may optionally be implemented by programmable codes executable for the computing devices, so that the components or steps may be stored in a storage device for execution with the computing devices, the shown or described steps may be executed in sequences different from those described here in some circumstances, or may form each integrated circuit component respectively, or multiple components or steps therein may form a single integrated circuit component for implementation. As a consequence, the present disclosure is not limited to any specific hardware and software combination.

The above is only the preferred embodiment of the present disclosure and not intended to limit the embodiment of the present disclosure, and for those skilled in the art, the present disclosure may have various modifications and variations. Any modifications, equivalent replacements, improvements and the like within the spirit and principle of the present disclosure shall fall within the scope of protection of the present disclosure.

### INDUSTRIAL APPLICABILITY

As mentioned above, according to the embodiments and example implementation modes, the problem that an effective parallel transmission link may not be established due to own characteristics of a WLAN in the related art and it is consequently impossible to directly implement parallel transmission in the WLAN is solved, and the effects of effectively avoiding interference to parallel transmission, effectively achieving compatibility with new and old equipment of the network and effectively improving efficiency of the network are further achieved.

What is claimed is:

1. A method for processing parallel transmission, comprising:
determining node types of multiple secondary nodes used for parallel transmission, wherein the node types comprise a second-type secondary node supporting or enabling parallel message processing;
determining, according to the determined node types, a resource negotiation manner used for negotiating resources of each secondary node for the parallel transmission;
determining corresponding resources corresponding to the multiple secondary nodes respectively according to the determined resource negotiation manner; and
performing parallel transmission processing on the multiple secondary nodes according to the corresponding resources.

2. The method as claimed in claim 1, wherein determining, according to the determined node types, the resource negotiation manner used for negotiating the resources of each secondary node for the parallel transmission comprises at least one of:
when the node types of the multiple secondary nodes further comprise a first-type secondary node not supporting or enabling the parallel message processing, determining that a resource negotiation manner of respective independent resource negotiation is adopted for the first-type secondary node and the second-type secondary node;
when the node types of the multiple secondary nodes merely comprise the second-type secondary nodes supporting or enabling the parallel message processing, determining that a resource negotiation manner of respective independent resource negotiation is adopted for the second-type secondary nodes; and
when the node types of the multiple secondary nodes merely comprise the second-type secondary nodes supporting or enabling the parallel message processing, determining that a resource negotiation manner of simultaneous parallel negotiation is adopted for the second-type secondary nodes.

3. The method as claimed in claim 2, wherein,
when the node types of the multiple secondary nodes further comprise the first-type secondary node not supporting or enabling the parallel message processing, determining the corresponding resources corresponding to the multiple secondary nodes respectively according to the determined resource negotiation manner comprises: sending, after corresponding resources of the first-type secondary node on a primary channel is determined, to the second-type secondary node a request message used for requesting for data transmission, wherein the request message sent to the second-type secondary node carries first resource range information of resources except the resources occupied by the first-type secondary node; and determining corresponding resources of the second-type secondary node according to a response message fed back by the second-type secondary node, wherein the response message fed back by the second-type secondary node carries information of corresponding resources of the second-type secondary node, wherein the corresponding resources of the second-type secondary node is selected by the second-type secondary node;
or,
when the node types of the multiple secondary nodes merely comprise the second-type secondary nodes supporting or enabling the parallel message processing, determining the corresponding resources corresponding to the multiple secondary nodes respectively according to the determined resource negotiation manner comprises: sending a request message used for requesting for data transmission to the second-type secondary node, wherein the request message carries second resource range information of resources for the second-type secondary node to select for parallel transmission; and determining corresponding resources of the second-type secondary node according to received response message sent by the second-type secondary node, wherein the response message carries information of the corresponding resources selected by the second-type secondary node according to the second resource range information.

4. The method as claimed in claim 3, wherein when the node types of the multiple secondary nodes further comprise the first-type secondary node not supporting or enabling the parallel message processing,
the request message sent to the second-type secondary node comprises at least one of: a unicast Request To Send, RTS, frame, a unicast predetermined frame and a multicast predetermined frame, wherein a reserved indicator bit in the unicast RTS frame indicates the carried first resource range information, and an information field of the unicast predetermined frame or the multicast predetermined frame indicates the carried first resource range information; and
the response message fed back by the second-type secondary node comprises a unicast Clear To Send (CTS) frame or a unicast predetermined response frame, wherein a reserved indicator bit in the CTS frame fed back by the second-type secondary node indicates the carried information of corresponding resources selected by the second-type secondary node, and an information field of the unicast predetermined response frame indicates the carried information of corresponding resources selected by the second-type secondary node.

5. The method as claimed in claim 3, wherein determining the corresponding resources corresponding to the multiple secondary nodes respectively according to the determined resource negotiation manner further comprises:
determining that resources corresponding to the first-type secondary node comprises primary channel resources, wherein transmission time of parallel transmission on a secondary channel is determined by data transmission time on the primary channel.

6. (canceled)

7. The method as claimed in claim 3, wherein when the node types of the multiple secondary nodes merely comprise the second-type secondary nodes supporting or enabling the parallel message processing,
the request message sent to the second-type secondary node comprises at least one of: a unicast RTS frame, a unicast predetermined frame and a multicast predetermined frame, wherein a reserved indicator bit in the RTS frame indicates the carried second resource range information, and an information field of the unicast predetermined frame/the multicast predetermined frame indicates the second resource range information for parallel transmission of the second-type secondary node; and
the response message fed back by the second-type secondary node comprises a unicast CTS frame or a unicast predetermined response frame, wherein a reserved indicator bit in the CTS frame indicates the carried information of the corresponding resources selected by the second-type secondary node, and an information field of the unicast predetermined response frame indicates the carried information of corresponding resources selected by the second-type secondary node.

8. The method as claimed in claim 1, wherein performing parallel transmission processing on the multiple secondary nodes according to the corresponding resources comprises:
sending corresponding data to the multiple secondary nodes at a same time by adopting different corresponding resources, wherein each piece of data sent to the second-type secondary node carries response parameter adjustment indication information used for adjusting response parameters of the corresponding secondary node responding to the data, and/or each piece of data sent to the second-type secondary node carries information used for requiring that the second-type secondary nodes immediately send in parallel the response information on different sub-channels.

9. The method as claimed in claim 8, before sending the corresponding data to the multiple secondary nodes at the same time by adopting different corresponding resources, further comprising:
acquiring response parameters corresponding to the multiple secondary nodes, wherein the response parameter adjustment indication information takes parameters of the first-type secondary node as a criterion when the multiple secondary nodes further comprise the first-type secondary node not supporting or enabling parallel message processing;
or,
acquiring response parameters corresponding to the multiple secondary nodes, wherein the response parameter adjustment information takes parameters of a primary node as a criterion.

10. The method as claimed in claim 8, wherein the response parameter adjustment indication information comprises at least one of:
power adjustment information used for adjusting a power of sending the response information, immediate response sending time point adjustment information used for adjusting a sending time point of the response information and carrier frequency offset pre-adjustment information used for adjusting a carrier frequency of sending the response information.

11. The method as claimed in claim 1, wherein the corresponding resources comprise at least one of:
frequency-domain resources, code division resources and space-domain resources.

12. The method as claimed in claim 3, wherein, when the corresponding resources are frequency-domain resources, the first resource range information and the second resource range information respectively comprise at least one of:
a starting position and bandwidth information of a frequency band;
a temporary primary channel position and bandwidth information of the frequency band;
the temporary primary channel position of the frequency band; and
sub-channel list information.

13. A device for processing parallel transmission, comprising:
a first determination component, configured to determine node types of multiple secondary nodes used for parallel transmission, wherein the node types comprise a second-type secondary node supporting or enabling parallel message processing;
a second determination component, configured to determine, according to the determined node types, a resource negotiation manner used for negotiating resources of each secondary node for the parallel transmission;
a third determination component, configured to determine corresponding resources corresponding to the multiple secondary nodes respectively according to the determined resource negotiation manner; and
a processing component, configured to perform parallel transmission processing on the multiple secondary nodes according to the corresponding resources.

14. The device as claimed in claim 13, wherein the second determination component comprises at least one of:
a first determination element, configured to, when the node types of the multiple secondary nodes further comprise a first-type secondary node not supporting or enabling the parallel message processing, determine that a resource negotiation manner of respective independent resource negotiation is adopted for the first-type secondary node and the second-type secondary node;
a second determination element, configured to, when the node types of the multiple secondary nodes merely comprise the second-type secondary nodes supporting or enabling the parallel message processing, determine that a resource negotiation manner of respective independent resource negotiation is adopted for the second-type secondary nodes; and
a third determination element, configured to, when the node types of the multiple secondary nodes merely comprise the second-type secondary nodes supporting or enabling the parallel message processing, determine that a resource negotiation manner of simultaneous parallel negotiation is adopted for the second-type secondary nodes.

15. The device as claimed in claim 13, wherein
the third determination component comprises: a first sending element, configured to, when the node types of the multiple secondary nodes further comprise the first-type secondary node not supporting or enabling the parallel message processing, send, after corresponding resources of the first-type secondary node on a primary channel is determined, to the second-type secondary node a request message used for requesting for data transmission, wherein the request message sent to the second-type secondary node carries first resource range information of resources except the resources occupied by the first-type secondary node; and a fourth determination element, configured to determine corresponding resources of the second-type secondary node according to the response message fed back by the second-type secondary node, wherein the response message fed back by the second-type secondary node carries information of corresponding resources of the second-type secondary node, wherein the corresponding resources of the second-type secondary node is selected by the second-type secondary node;
or,
the third determination component comprises: a second sending element, configured to, when the node types of the multiple secondary nodes merely comprise the second-type secondary nodes supporting or enabling the parallel message processing, send a request message used for requesting for data transmission to the second-type secondary node, wherein the request message carries second resource range information of resources for the second-type secondary node to select for parallel transmission; and a sixth determination element, configured to determine corresponding resources of the second-type secondary node according to received response message sent by the second-type secondary node, wherein the response message carries information of the corresponding resources selected by the second-type secondary node according to the second resource range information.

16. The device as claimed in claim 15, wherein the third determination component further comprises:
a fifth determination element, configured to determine that the resources corresponding to the first-type secondary node comprises primary channel resources, wherein transmission time of parallel transmission on a secondary channel is determined by data transmission time on the primary channel.

17. (canceled)

18. The device as claimed in claim 13, wherein the processing component comprises:
a third sending element, configured to send corresponding data to the multiple secondary nodes at a same time by adopting different corresponding resources, wherein each piece of data sent to the second-type secondary node carries response parameter adjustment indication information used for adjusting response parameters of the corresponding secondary node responding to the data.

19. The device as claimed in claim 18, further comprising:
an acquisition element, configured to acquire response parameters corresponding to the multiple secondary nodes, wherein the response parameter adjustment indication information takes a response parameter of the first-type secondary node as a criterion when the multiple secondary nodes further comprise the first-type secondary node not supporting or enabling parallel message processing;
or,
acquiring response parameters corresponding to the multiple secondary nodes, wherein the response parameter adjustment information takes parameters of a primary node as a criterion.

20. Equipment for processing parallel transmission, comprising the device as claimed in claim 13.

21. A computer storage medium, in which an execution instruction is stored, wherein the execution instruction is configured to execute the method as claimed in claim 1.

22. The method as claimed in claim 8, wherein all or part of the response parameter adjustment indication information is positioned in an MAC header of the data frame, or positioned in a physical layer frame header of the data frame, wherein all or part of the response parameter adjustment indication information is positioned in a reserved bit of the MAC header, or positioned in an additional information field of the MAC header.

23. The method as claimed in claim 3, wherein when the node types of the multiple secondary nodes merely comprise the second-type secondary nodes supporting or enabling the parallel message processing,
the request message sent to the second-type secondary node comprises at least one of: a groupcast multi-user RTS frame, and a groupcast predetermined frame, wherein an information field of the groupcast predetermined frame/the multi-user RTS frame frame indicates the second resource range information for parallel transmission of each second-type secondary node; and
the response message fed back by each second-type secondary node comprises a unicast CTS frame or a unicast predetermined response frame, wherein the unicast CTS frame or the unicast predetermined response frame is sending on resource that indicated by the second resource range information.

24. A method for processing parallel transmission, comprising:
receiving a request message from a primary node, wherein the request message is used for requesting for data transmission, and the request message carries resources negotiation or indication information used for parallel transmission.
sending a response message to the primary node on resources indicated in the resources negotiation or indication information;
performing parallel transmission processing with the primary node.

25. The method as claimed in claim 24, wherein
the message comprises at least one of: a unicast RTS frame, a predetermined frame, a groupcast multi-user RTS frame, a predetermined groupcast frame; and
the response message comprises a unicast CTS frame or a unicast predetermined response frame.

26. The method as claimed in claim 24, wherein before sending a response message to the primary node on resources indicated in the resources negotiation or indication information, further comprising:
acquiring response parameter adjustment indication information used for adjusting a response parameter of sending the response message;
adjusting the response parameter of sending the response message.

27. The method as claimed in claim 26, wherein the response parameter adjustment indication information comprises at least one of following:
power adjustment information used for adjusting a power of sending the response message, immediate response sending time point adjustment information used for adjusting a sending time point of the response message, and carrier frequency offset pre-adjustment information used for adjusting a carrier frequency of sending the response message.
